(19) United States
(12) Patent Application Publication
(10) Pub. No.: US 2024/0301733 A1
(43) Pub. Date: Sep. 12, 2024

(54) SLIDING-OUT TYPE DOOR ASSEMBLY FOR VEHICLE WITH EASY POSITION ADJUSTMENT STRUCTURES AND METHOD OF ADJUSTING POSITION OF DOOR USING THE SAME

(71) Applicants: Hyundai Motor Company, Seoul (KR); Kia Corporation, Seoul (KR)

(72) Inventor: Seung-Young Park, Hwaseong-si (KR)

(21) Appl. No.: 18/479,287

(22) Filed: Oct. 2, 2023

(30) Foreign Application Priority Data
Mar. 9, 2023 (KR) 10-2023-0031111

(51) Int. Cl. E05D 15/06; B60J 5/06; E05D 15/28

(52) U.S. Cl. CPC E05D 15/0626; B60J 5/06; E05D 15/28; E05Y 2600/12; E05Y 2600/312; E05Y 2600/314; E05Y 2600/51; E05Y 2600/56; E05Y 2600/62; E05Y 2600/626; E05Y 2900/506

(57) ABSTRACT

An embodiment sliding-out type door assembly for a vehicle includes a door coupled to a vehicle body of the vehicle, a housing in which the door is slidably installed in a front-rear direction of the vehicle, a mounting bracket disposed in the front-rear direction of the vehicle and slidably fastened in the front-rear direction of the vehicle by a predetermined length, the mounting bracket including a plurality of forward and rearward adjustment long holes in the front-rear direction of the vehicle, a step adjustment bracket fastened to each of the mounting bracket and the housing, and forward and rearward adjustment bolts passing through the forward and rearward adjustment long holes and fastened to the vehicle body.

### CROSS-REFERENCE TO RELATED APPLICATIONS

This application claims the benefit of Korean Patent Application No. 10-2023-0031111, filed on Mar. 9, 2023, which application is hereby incorporated herein by reference in its entirety.

### TECHNICAL FIELD

The present disclosure relates to a sliding-out type door assembly for a vehicle with easy position adjustment structures and a method of adjusting a position of a door using the sliding-out type door assembly.

### BACKGROUND

A door for occupants to get on and off is installed on a vehicle.

In a vehicle such as a bus, a sliding-out type door is installed on a side surface thereof and opened or closed so that occupants get on or off the vehicle.

The sliding-out type door has a problem that assemblability is degraded because the configuration for operating the door is complicated and the door is heavy.

Since the configuration for operating the door is complicated, the door needs to be assembled at a correct position so that a step-like misalignment or a gap does not occur with respect to the vehicle body.

In addition, since a position of the door can be changed or deformed when the door is repeatedly operated for a long time, the position of the door needs to be adjusted.

However, since the door is a heavy object, there is a problem in that it is not easy to align the door to a correct position.

There is a problem in that such deformation forms a step-like misalignment or a gap between a circumference of the door and the vehicle body, thereby degrading sealing performance between the door and the vehicle body, and thus foreign substances, noises, and traveling wind are introduced through the gap from the outside.

### SUMMARY

The present disclosure relates to a sliding-out type door assembly for a vehicle with easy position adjustment structures and a method of adjusting a position of a door using the sliding-out type door assembly. Particular embodiments relate to a sliding-out type door assembly for a vehicle with easy position adjustment structures which may easily adjust a position of a door installed on a vehicle in a front-rear direction, a height direction, and a width direction of the vehicle during assembly or maintenance to prevent generation of a gap between the door and a vehicle body when the door is closed and a method of adjusting a position of a door using the sliding-out type door assembly.

An embodiment of the present disclosure provides a sliding-out type door assembly for a vehicle with easy position adjustment structures that easily adjusts a position of a sliding-out type door in each direction in a process of assembling the door to a vehicle or from a state in which the door has been assembled so that a gap does not occur between the door and a vehicle body.

A sliding-out type door assembly for a vehicle with easy position adjustment structures may include a door of a vehicle, a housing in which the door is slidably installed in a front-rear direction of the vehicle, a mounting bracket disposed in the front-rear direction of the vehicle and slidably fastened in the front-rear direction of the vehicle by a predetermined length, and a step adjustment bracket fastened to each of the mounting bracket and the housing, wherein a plurality of forward and rearward adjustment long holes is formed in the mounting bracket in the front-rear direction of the vehicle, and forward and rearward adjustment bolts may pass through the forward and rearward adjustment long holes and may be fastened to a body of the vehicle.

An upper portion of the step adjustment bracket may be bent to overlap an end portion of the housing, a plurality of horizontal adjustment long holes may be formed in the form of a long hole in a width direction of the vehicle, and horizontal adjustment bolts may pass through the horizontal adjustment long holes and may be fastened to the housing.

The sliding-out type door assembly may further include a transfer frame disposed in the width direction of the vehicle, having a roller moving in the width direction of the vehicle installed thereon, and coupled to the end portion of the housing, and fastening plates inserted into the transfer frame in the width direction of the vehicle and fastened to lower end portions of the horizontal adjustment bolts.

A fastening part extending to be bent inward from an end portion of the mounting bracket in a width direction of the vehicle may be formed, vertical adjustment long holes formed in a height direction of the vehicle may be formed in a lower end portion of the step adjustment bracket, and vertical adjustment bolts may pass through the vertical adjustment long holes and may be fastened to mounting holes formed in the fastening part.

Extensions protruding to an opposite side of the housing may be formed on a portion of the step adjustment bracket which is bent to overlap the end portion of the housing, fine adjustment nuts may be provided on the extensions, and fine adjustment bolts screw-coupled to the fine adjustment nuts and having lower end portions in contact with the fastening part may be provided.

Meanwhile, a method of adjusting a position of a sliding-out type door assembly for a vehicle with easy position adjustment structures according to an exemplary embodiment of the present disclosure may include a mounting bracket temporary assembly operation of loosening forward and rearward adjustment bolts, which fastens a mounting bracket equipped with a door assembly provided with a door of a vehicle to a body of the vehicle, so that the mounting bracket is in a state of being temporarily assembled, a forward and rearward adjustment operation of adjusting a position of the door in a front-rear direction of the vehicle by moving the mounting bracket in the front-rear direction of the vehicle, and a forward and rearward adjustment completion operation of tightening the forward and rearward adjustment bolts so that the adjusted position of the mounting bracket is maintained.

In addition, a method of adjusting a position of a sliding-out type door assembly for a vehicle with easy position adjustment structures according to an exemplary embodiment of the present disclosure may include a housing temporary assembly operation of loosening horizontal adjustment bolts, which fasten a housing in which a door of a vehicle is installed to a step adjustment bracket mounted on a mounting bracket installed on a vehicle body so that the housing is in a state of being temporarily assembled, a horizontal adjustment operation of adjusting a position of the door in a front-rear direction of the vehicle by moving the housing in a width direction of the vehicle, and a horizontal adjustment completion operation of tightening the horizontal adjustment bolts so that the adjusted position of the housing is maintained.

In addition, a method of adjusting a position of a sliding-out type door assembly for a vehicle with easy position adjustment structures according to an exemplary embodiment of the present disclosure may include a step adjustment bracket temporary assembly operation of loosening vertical adjustment bolts, which fasten a step adjustment bracket to a mounting bracket installed on a vehicle body, so that the step adjustment bracket is in a state of being temporarily assembled, a vertical adjustment operation of adjusting a position of the door in a height direction of the vehicle by moving the step adjustment bracket in the height direction of the vehicle, and a vertical adjustment completion operation of tightening the vertical adjustment bolts so that the adjusted position of the step adjustment bracket is maintained.

The vertical adjustment operation may include adjusting degrees of fine adjustment bolts fastened to the step adjustment bracket and adjusting a height of the step adjustment bracket by lower end portions of the fine adjustment bolts pushing the mounting bracket.

In addition, a sliding-out type door assembly for a vehicle with easy position adjustment structures according to an embodiment of the present disclosure includes a door of a vehicle, door arms moving the door while moving along a sliding guide disposed in a front-rear direction of the vehicle and having door arm plates provided on lower portions thereof, and mounting plates mounted inside a door frame of the door, wherein vertical long holes are formed in the door frame in a height direction of the vehicle, and fastening bolts may pass through the door arm plates and the door frame and may be fastened to the mounting plates.

Horizontal long holes may be formed in the door frame in a front-rear direction of the vehicle, and rotating cams, which have a shape center and a rotation center eccentrically formed, may be rotatably installed on the mounting plates and positioned inside the horizontal long holes.

An operation surface may be formed on a circumference of the rotating cam in a planar shape.

A pair of mounting plates may be disposed on the door frame at an interval, and the rotating cams may be installed on each of the mounting plates.

Through-holes to which the rotating cams are exposed may be formed in the door arm plates, and caps may be coupled to the through-holes.

Meanwhile, a method of adjusting a position of a sliding-out type door assembly for a vehicle with easy position adjustment structures according to an exemplary embodiment of the present disclosure may include a door arm plate temporary assembly operation of loosening fastening bolts, which assemble door arm plates, which are provided on lower portions of door arms sliding a door of a vehicle, and mounting plates, which are positioned inside a door frame, so that the door arm plates are in a state of being temporarily assembled, a door height adjustment operation of adjusting a position of the door by moving the door in a height direction of the vehicle, and a door adjustment completion operation of fastening the door arm plates to the mounting plates by tightening the fastening bolts.

The method may further include a rotating cam rotation operation of rotating cams mounted on the mounting plates so that heights of one end portion and the other end portion of the door are differently adjusted between the door height adjustment operation and the door adjustment completion operation.

According to the sliding-out type door assembly for a vehicle with easy position adjustment and the method of adjusting the step thereof, it is possible to easily adjust the position of the door in each direction of a vehicle in the process of assembling the door of the sliding-out type door or during maintenance.

Since the position of the door can be easily adjusted, the gap formed between the door and the vehicle body does not occur, and thus it is possible to improve the sealing performance between the door and the vehicle body.

Therefore, it is possible to prevent the phenomenon in which foreign substances, noises, traveling wind, or the like is introduced into the vehicle from the outside.

### BRIEF DESCRIPTION OF THE DRAWINGS

FIG. 1 is a perspective view illustrating a sliding-out type door assembly for a vehicle with easy position adjustment structures according to embodiments of the present disclosure.

FIGS. 2A and 2B are a bottom perspective view and a plan view illustrating an operation mechanism of the sliding-out type door assembly for a vehicle with easy position adjustment structures according to embodiments of the present disclosure.

FIGS. 3A and 3B are a bottom perspective view and a plan view illustrating a state in which a door is closed in the sliding-out type door assembly for a vehicle with easy position adjustment structures according to embodiments of the present disclosure.

FIGS. 4A and 4B are a bottom perspective view and a plan view illustrating a state in which the door is opened in the sliding-out type door assembly for a vehicle with easy position adjustment structures according to embodiments of the present disclosure.

FIG. 5 is a perspective view illustrating a portion indicated by A in FIG. 1.

FIG. 6 is an exploded perspective view illustrating the portion indicated by A in FIG. 1.

FIG. 7 is a schematic diagram illustrating a process of adjusting a position of the door in a height direction of the vehicle at the portion indicated by A in FIG. 1.

FIG. 8 is a perspective view illustrating a portion indicated by B in FIG. 1.

FIG. 9 is a front view illustrating the portion indicated by B in FIG. 1.

FIG. 10 is an exploded perspective view illustrating the portion indicated by B in FIG. 1.

FIGS. 11 to 14 are respective flow charts each illustrating a step of adjusting a position of the sliding-out type door assembly for a vehicle with easy position adjustment structures according to embodiments of the present disclosure.

### DETAILED DESCRIPTION OF ILLUSTRATIVE EMBODIMENTS

Hereinafter, a sliding-out type door assembly for a vehicle with easy position adjustment structures and a method of adjusting a position of a door using the same according to embodiments of the present disclosure will be described in detail with reference to the accompanying drawings.

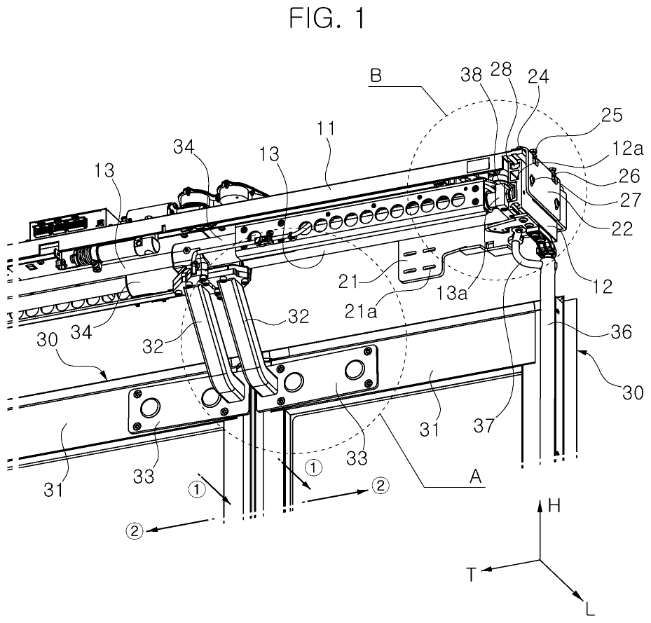

An exemplary sliding-out type door 30 is shown in FIG. 1. The sliding-out type door 30 slides along an outer surface of the vehicle after the door moves a predetermined distance to an outside of the vehicle in a width direction. The sliding-out type door 30 is installed as a single type or a double type depending on application positions or an effective width of the door 30. For example, when the doors 30 are installed in the double type, a pair of doors 30 move together to the outside of the vehicle in the width direction (see arrows \textcircled{1} in FIG. 1) and then each moves in opposite directions, i.e., a front and rear direction of the vehicle (see arrows \textcircled{2} in FIG. 1).

A driving unit including components such as actuators, belts, and various controllers for operating the door 30 is installed in a housing 11 mounted on a vehicle body to operate the door 30 according to an opening or closing signal from a controller (not shown).

Meanwhile, the sliding-out type door 30 has a problem that assemblability is degraded because the configuration for operating the door 30 is complicated and the door 30 is heavy.

Since the configuration for operating the door 30 is complicated, the door 30 needs to be assembled at a correct position so that a step-like misalignment or a gap does not occur with respect to the vehicle body.

In addition, since a position of the door 30 can be changed or deformed when the door 30 is repeatedly operated for a long time, the position of the door 30 needs to be adjusted.

However, since the door 30 is a heavy object, there is a problem in that it is not easy to align the door 30 to a correct position.

There is a problem in that such deformation forms a step-like misalignment or a gap between a circumference of the door 30 and the vehicle body, thereby degrading sealing performance between the door 30 and the vehicle body, and thus foreign substances, noises, and traveling wind are introduced through the gap from the outside.

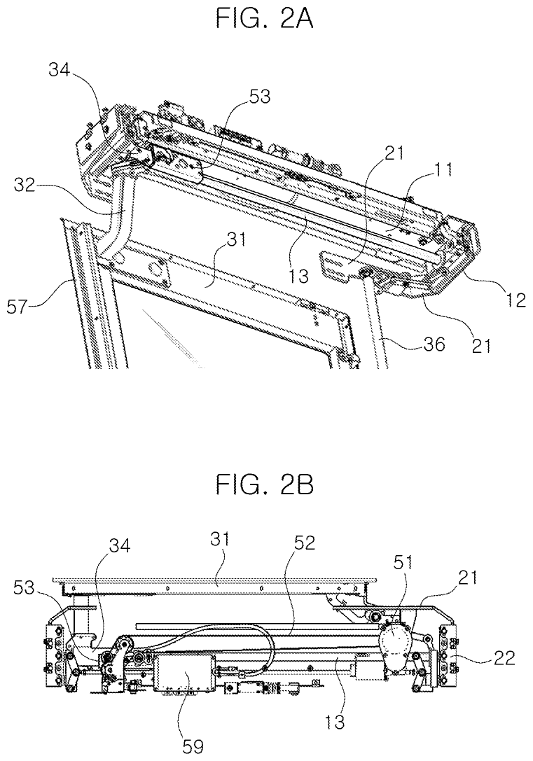

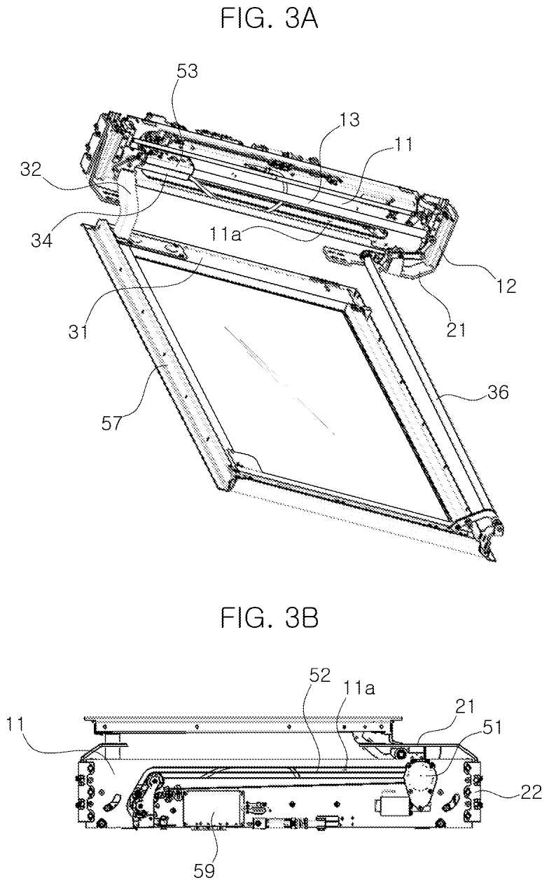

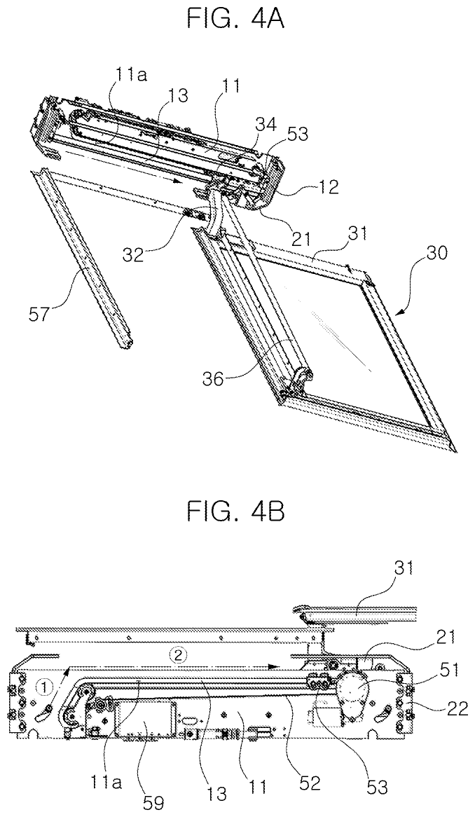

The sliding-out type door 30 may have a structure as shown in FIGS. 2A to 4B and slides in a front-rear direction T of the vehicle when a motor unit 51 operates according to a control signal of a controller 59.

A housing 11 may be provided so that the motor unit 51 or the like is mounted on the vehicle, and a transfer frame 12 may be fastened to an end portion of the housing 11. The housing 11 may be mounted on a vehicle body through a mounting bracket 21 and a step adjustment bracket 22.

A rail 11a may be formed on the housing 11 to correspond to a movement trajectory of the door 30. The rail 11a may be formed in the form of a slit in the housing 11. When the door is opened, since the door 30 moves to an outside of the vehicle by a predetermined distance and then moves in a longitudinal direction of the vehicle, the rail 11a may move outward by the predetermined distance and then may be formed in the form of extending in the longitudinal direction of the vehicle.

A sliding guide 13 for guiding the movement of the door 30 in the longitudinal direction of the vehicle may be provided inside the housing 11. After the sliding guide 13 moves in the width direction of the vehicle together with the door 30 at the initial stage of opening the door 30 (when the door moves in the direction of \textcircled{1} in FIG. 1), the sliding guide 13 guides the door 30 to move in the longitudinal direction of the vehicle. A slider 34 may be slidably installed on the sliding guide 13 and fastened to a roller unit 53. The slider 34 moves integrally with the roller unit 53 because it is fastened to the roller unit 53.

One end portion of the sliding guide 13 may be connected to the roller unit 53, and the other end portion thereof may be connected to a transfer wheel 38.

The roller unit 53 moves along the rail 11a. When the motor unit 51 operates, the roller unit 53 moves along the rail 11a by a belt 52 installed in the housing 11 to circulate along a predetermined trajectory.

The transfer wheel 38 may be installed inside the transfer frame 12 to travel in a width direction L of the vehicle. A wheel guide 12a may be formed inside the transfer frame 12 in the width direction L of the vehicle, and the transfer wheel 38 may be installed on the wheel guide 12a. A moving block 13a may be formed at an end portion of the sliding guide 13, and the transfer wheel 38 may be rotatably installed on the moving block 13a.

Therefore, when the motor unit 51 moves the roller unit 53 along the rail 11a, the sliding guide 13 moves in the width direction of the vehicle and then the slider 34 moves along the sliding guide 13. When the roller unit 53 moves the sliding guide 13 in the width direction of the vehicle, the transfer wheel 38 connected to the other end portion of the sliding guide 13 also moves in the width direction L of the vehicle.

An upper end portion of a door arm 32 may be fastened to the slider 34 and a lower end portion thereof may be fastened to one end portion of the door 30. As the door arm 32 moves by the movement of the slider 34, the door 30 moves in the width direction of the vehicle and then slides in the longitudinal direction of the vehicle.

A rod 36 is provided having an upper end portion installed at the other end portion of the door 30 to slide and rotate with respect to the transfer frame 12 and disposed in the height direction of the vehicle, and an upper portion of the rod 36 may be connected to the moving block 13a through a connection bracket 37.

When the door 30 is in a closed state, an outer surface of the vehicle and an outer surface of the door 30 may be on the same surface, making the sliding of the door 30 impossible. Therefore, in order to slide the door 30, the door 30 first needs to be moved to the outside of the vehicle by a predetermined distance. To open the door 30, the sliding guide 13 and the transfer wheel 38 may be moved to the outside of the vehicle by the predetermined distance within the transfer frame 12. When the motor unit 51 moves the roller unit 53 along the rail 11a through the belt 52, the door 30 is opened while the slider 34 and the door arm 32 may move integrally with the roller unit 53.

At the initial stage of opening, since the roller unit 53 moves in the width direction of the vehicle, the door 30 moves in the vehicle width direction by the predetermined distance while the slider 34 and the door arm 32 also move in the width direction of the vehicle.

Thereafter, while the roller unit 53 moves along the rail 11a, the slider 34 moves along the sliding guide 13, and at the same time, the door 30 fastened to the door arm 32 moves along the longitudinal direction of the vehicle, thereby securing a sufficient space for passengers to get on and off.

When the door 30 is closed, the door 30 may be returned by first sliding the door 30 in an opposite direction and then moving the transfer frame 12 to an inside of the vehicle.

Since a configuration of moving the door 30 in the width direction L or the front-rear direction T of the vehicle does not correspond to embodiments of the present disclosure, a detailed description thereof will be omitted.

There is a case in which the door 30 has a distribution occurring during an assembly process or is displaced from the correction position due to a long-term use. When the door 30 is displaced from the correction position, a gap occurs between a circumference of the door 30 and a body weather strip 57, and foreign substances may be introduced from the outside through the gap. When the door 30 is closed, the position of the door 30 may be moved in the front-rear direction T, the width direction L, and the height direction H of the vehicle so that the gap is not formed between the door 30 and the body weather strip 57.

To this end, in embodiments of the present disclosure, by adjusting the position of the door 30 at a portion of the door arm 32 connected to the door 30 (see A in FIG. 1) or a portion of the housing 11 fastened to the mounting bracket 21 and the step adjustment bracket 22 (see B in FIG. 1), the door 30 may be adjusted to be positioned at the correction position.

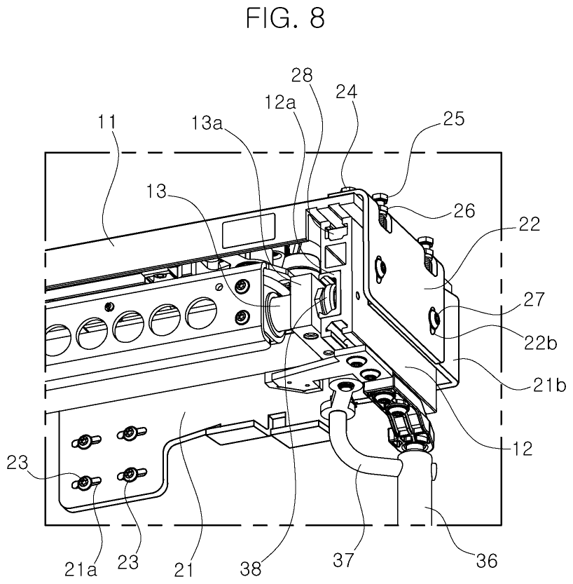

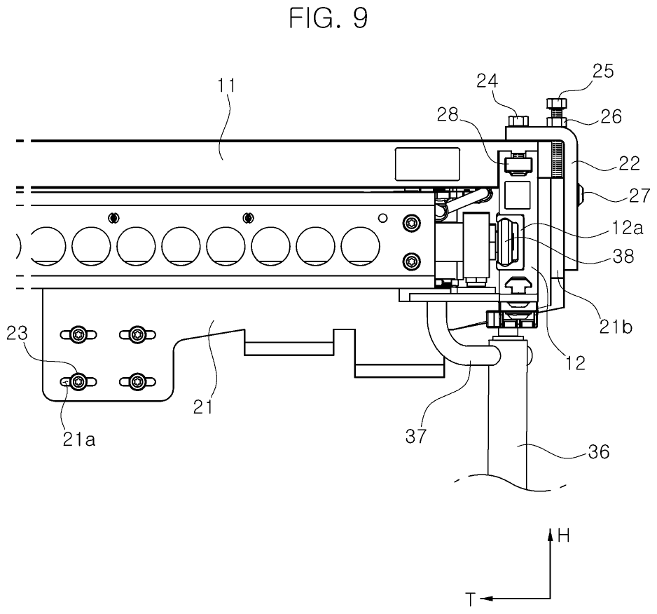

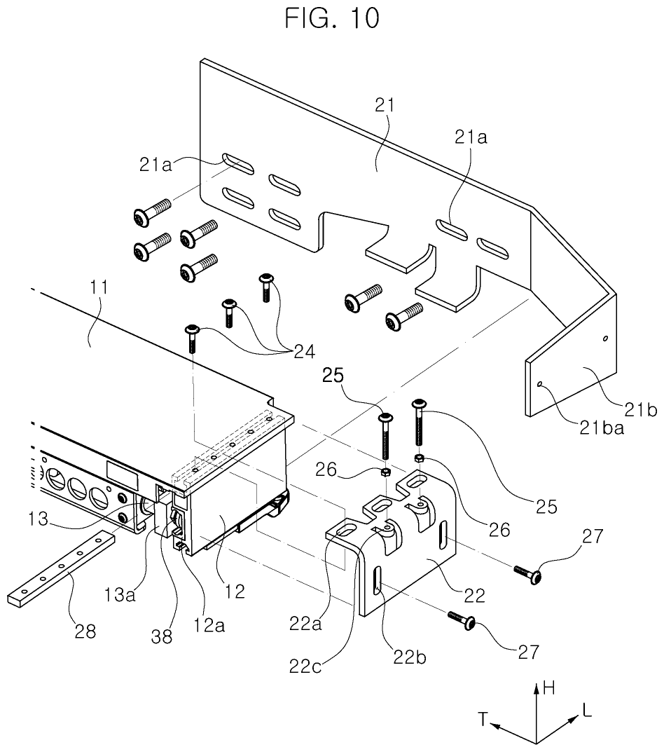

First, FIGS. 8 to 10 show a configuration in which the step of the door 30 is adjusted by adjusting the position of the door arm 32 fastened to the door 30.

A door frame 31 forming an exterior of the door 30 may be formed on the circumference of the door 30, and the door arm 32 may be fastened to the door frame 31. Vertical long holes 31a and horizontal long holes 31b for fastening the door arm 32 may be formed in the door frame 31. The vertical long hole 31a may be used to adjust the position of the door 30 in the height direction H of the vehicle, and the horizontal long hole 31b may be used to adjust the position of the door 30 when one end portion and the other end portion of the door 30 are differently adjusted.

An upper portion of the door arm 32 may be fastened to the slider 34 fitted into the sliding guide 13, and a lower portion thereof has a door arm plate 33 formed thereon. The door arm plate 33 may be fastened to the door frame 31. Fastening holes 33a and through-holes 33b corresponding to the vertical long holes 31a and the horizontal long holes 31b may be formed in the door arm plate 33.

The rotating cam 42 may be rotatably installed in a cam installation hole 41a of the mounting plate 41, and the mounting plate 41 may be fastened to the door arm plate 33 and the door frame 31. The rotating cam 42 may be rotatably installed on the mounting plate 41 through a cam fixing bolt 43. A rotation center of the rotating cam 42 may be formed at a position eccentric with the center of the shape. That is, since the cam fixing bolt 43 passes through the rotating cam 42 and is fastened to the mounting plate 41 at the position eccentric with the center of the rotating cam 42, the position of the door 30 may be adjusted when the rotating cam 42 rotates.

In addition, an operating surface 42a may be formed on the rotating cam 42 so that the rotating cam 42 may be easily rotated with a tool when the position of the door 30 is adjusted. When the rotating cam 42 is temporarily assembled with the cam fixing bolt 43, the rotating cam 42 may be rotated with the tool.

A pair of mounting plates 41 may be provided and mounted on the door frame 31, and the rotating cam 42 may be installed on each mounting plate 41.

The door arm plate 33, the door frame 31, and the mounting plates 41 may be fastened with fastening bolts 44. The fastening bolts 44 pass through the fastening holes 33a of the door arm plate 33 and the vertical long holes 31a of the door frame 31 and may be fastened to the fastening holes 41b of the mounting plates 41.

In this case, the rotating cams 42 may be positioned in the horizontal long holes 31b.

When an operation of the rotating cam 42 is completed, caps 45 may be coupled to the through-holes 33b to prevent the rotating cams 42 from being exposed.

According to the method of adjusting the step of the sliding-out type door assembly for a vehicle according to embodiments of the present disclosure, a process of adjusting the position of the door 30 at the portion in which the door arm 32 is connected to the door 30 is as follows.

As shown in FIG. 14, the method of adjusting the step of the sliding-out type door assembly for a vehicle according to embodiments of the present disclosure includes a door arm plate temporary assembly operation S211, a door height adjustment operation S213, a rotating cam rotation operation S215, and a door adjustment completion operation S217.

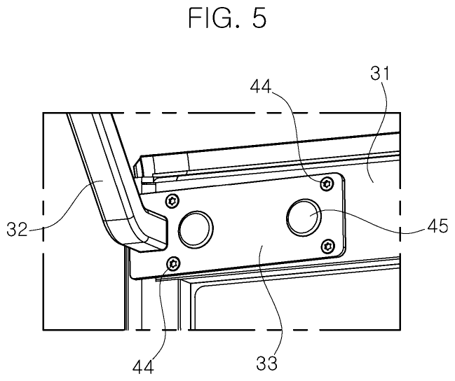

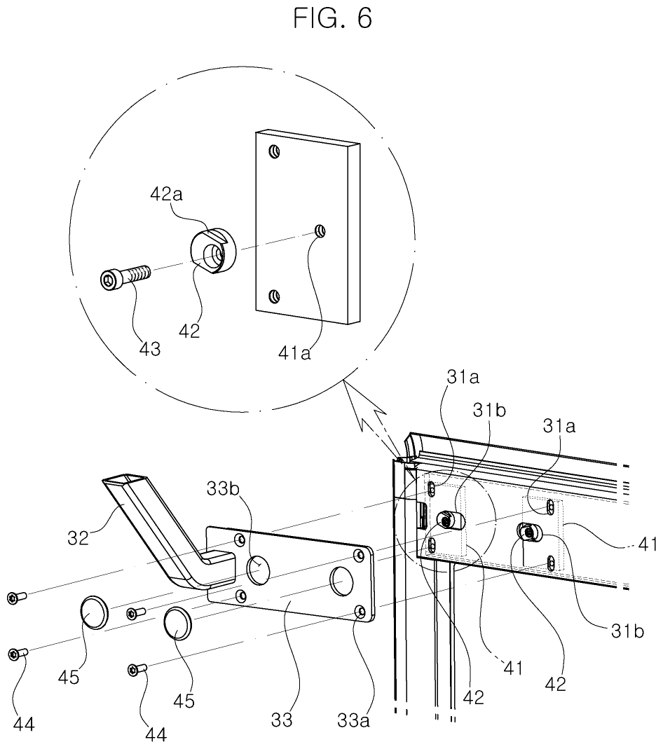

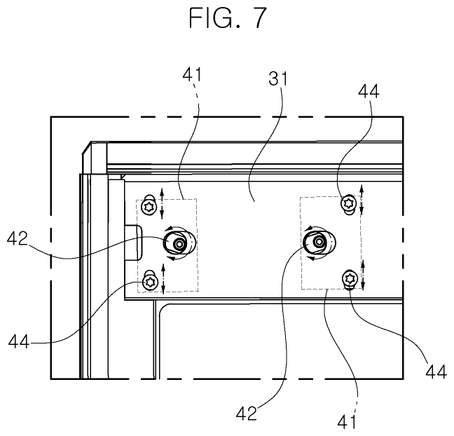

In the door arm plate temporary assembly operation S211, the fastening bolts 44 for assembling the door arm plates 33 and the mounting plates 41 may be loosened so that the door arm plates 33 are in a state of being temporarily assembled. Since the door arm plates 33 are fastened to the door arms 32 by the fastening bolts 44, each of the fastening bolts 44 may be partially loosened so that the door arm plate 33 is in the state of being temporarily assembled. For example, as shown in FIGS. 5 to 7, when four fastening bolts 44 are applied, each of the four fastening bolts 44 may be partially released so that the door arm plates 33 are in the state of being temporarily assembled. Here, the state of being temporarily assembled includes both a state in which the completely fastened fastening bolts 44 are partially loosened and a state before completely fastening the fastening bolts 44 during assembly.

In the door height adjustment operation S213, the door 30 may be moved in the height direction H to adjust the position of the door 30. When the fastening bolts 44 are in the state of being temporarily assembled, since the position of the door 30 may be moved, the position of the door 30 may be adjusted by moving the door 30 in the height direction H of the vehicle.

In the rotating cam rotation operation S215, the rotating cams 42 mounted on the mounting plates 41 may be rotated so that the heights of one end portion and the other end portion of the door 30 are adjusted differently. The heights of the one end portion (side to which the door arm plate is fastened) and the other end portion of the door 30 may be adjusted differently using the rotating cam 42. Therefore, in the rotating cam rotation operation S215, when the caps 45 are separated and the rotating cams 42 are rotated using a tool, the mounting plates 41 and the door frame 31 may be relatively moved in the height H of the vehicle to adjust the height of the door 30. When the rotating cam 42 is rotated, the door frame 31 may move up and down with respect to the mounting plates 41 so that the height of the door 30 is adjusted.

In particular, when a pair of rotating cams 42 is disposed and rotated in opposite directions, the one end portion and the other end portion of the door 30 rotate in opposite directions to adjust an installation angle of the door 30. However, since the door 30 may be rotated within a range in which a clearance between the vertical long hole 31a and the fastening bolt 44 is allowable, the amount of rotation is not large.

In the door adjustment completion operation S217, the door arm plates 33 may be fastened to the mounting plates 41 by tightening the fastening bolts 44. When the position of the door 30 is adjusted through the door height adjustment operation S213 and the door adjustment completion operation S217, the fastening bolts 44 may be completely fastened so that the adjusted position of the door 30 is maintained.

FIGS. 8 to 10 show a configuration for adjusting a position of the transfer frame 12 with respect to the housing 11. Since the housing 11 is installed on the vehicle body through the mounting brackets 21 and the step adjustment brackets 22, the position of the door 30 is adjusted by adjusting the position of the housing 11.

The mounting bracket 21 may be fastened to the vehicle body. Front and rear adjustment long holes 21a may be formed in the mounting bracket 21 in the front-rear direction T of the vehicle, and forward and rearward adjustment bolts 23 may pass through the forward and rearward adjustment long holes 21a and may be fastened to the vehicle body. The mounting bracket 21 may be formed in the front-rear direction T of the vehicle and has fastening parts 21b bent toward the inside of the vehicle formed on both end portions thereof. Mounting holes 21ba for fastening the mounting brackets 21 to the step adjustment brackets 22 may be formed in the fastening part 21b.

The step adjustment brackets 22 may be fastened to end portions of the housing 11 in the front-rear direction. The transfer frame 12 disposed in the width direction L of the vehicle may be fastened to the end portions of the housing 11 in the front-rear direction, and the step adjustment brackets 22 may be formed in the form of covering the housing 11 and the transfer frame 12. That is, a middle portion of the step adjustment bracket 22 may be bent so that an upper portion of the step adjustment bracket 22 covers the end portion of the housing 11 and the remaining portion of the step adjustment bracket 22 may be disposed parallel to the transfer frame 12. Left and right adjustment long holes 22a may be formed in an upper surface of the step adjustment bracket 22. The horizontal adjustment long holes 22a may be formed in the width direction L of the vehicle. Left and right adjustment bolts 24 pass through the horizontal adjustment long holes 22a and the through holes formed in the housing 11 and may be fastened to fastening plates 28 inserted into the transfer frame 12. Therefore, the step adjustment bracket 22, the housing 11, and the transfer frame 12 may be fastened to one another.

Extensions 22C extending from the upper surface of the step adjustment bracket 22 may be formed in a direction opposite to a direction in which the horizontal adjustment long holes 22a are formed on the upper surface of the step adjustment bracket 22. Fastening holes may be formed in the extensions 22C, and fine adjustment bolts 25 may pass through the fastening holes. In addition, fine adjustment nuts 26 may be mounted on the extensions 22C, and the fine adjustment bolts 25 may be screw-coupled to the fine adjustment nuts 26. By adjusting a degree of the fine adjustment bolts 25 fastened to the fine adjustment nuts 26, lower end portions of the fine adjustment bolts 25 may be in contact with an upper portion of the fastening part 21b to restrict the position of the fastening part 21b.

Upper and lower adjustment long holes 22b may be formed in the side surface of the step adjustment bracket 22. Upper and lower adjustment bolts 27 may pass through the vertical adjustment long holes 22b and may be fastened to the mounting holes 21ba formed in the fastening part 21b of the mounting bracket 21. Therefore, the mounting bracket 21 and the step adjustment bracket 22 may be fastened. The fine adjustment bolts 25 and the vertical adjustment bolts 27 may be in the state of being temporarily assembled by being partially loosened, and the position of the door 30 may be adjusted by re-tightening the fine adjustment bolts 25 and the vertical adjustment bolts 27 after adjusting the position of the step adjustment bracket 22.

The method of adjusting the step of the door 30 in the sliding-out type door assembly for a vehicle to which the mounting bracket 21 and the step adjustment bracket 22 are applied will be described.

When the mounting bracket 21 and the step adjustment bracket 22 are applied, the step of the door 30 may be adjusted in the front-rear direction T, the width direction L, and the height direction H of the vehicle, and the step of the door 30 may be independently adjusted with respect to each direction.

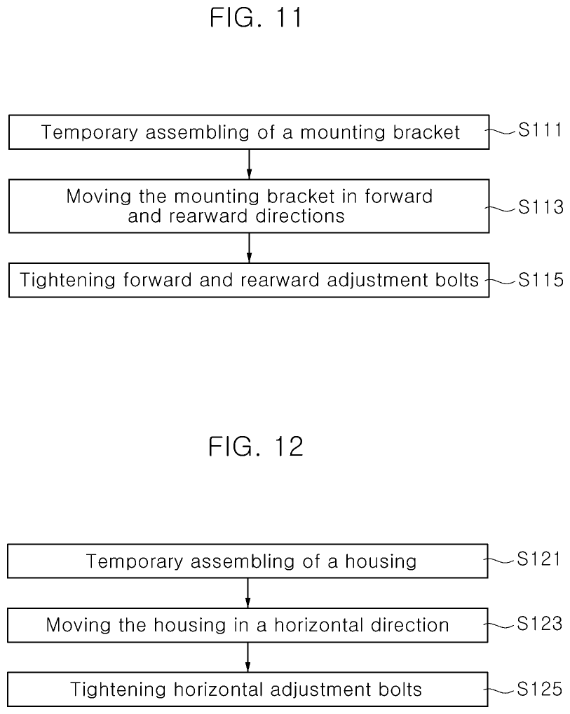

First, as shown in FIG. 11, the method of adjusting the step of the sliding-out type door assembly for a vehicle of adjusting the position of the door 30 in the front-rear direction T of the vehicle will be described. The method of adjusting the step of the door 30 in the front-rear direction T includes a mounting bracket temporary assembly operation S111, a forward and rearward adjustment operation S113, and a forward and rearward adjustment completion operation S115.

In the mounting bracket temporary assembly operation S111, the forward and rearward adjustment bolts 23 fastening the mounting bracket 21 equipped with the door assembly provided with the door 30 of the vehicle may be loosened so that the mounting bracket 21 is in the state of being temporarily assembled. When the forward and rearward adjustment bolts 23 are partially loosened, the mounting bracket 21 becomes in a state of being slidable in the front-rear direction T of the vehicle.

In the forward and rearward adjustment operation S113, the position of the door 30 may be adjusted in the front-rear direction of the vehicle by moving the mounting bracket 21 in the front-rear direction T of the vehicle. When the mounting bracket 21 is moved in the front-rear direction T of the vehicle, the position of the mounting bracket 21 may be adjusted. When the mounting bracket 21 is moved in the front-rear direction T of the vehicle, the step adjustment bracket 22 and the housing 11 move together with the mounting bracket 21. In addition, various components installed in the housing 11 and the door 30 may move in the front-rear direction T of the vehicle. Therefore, by moving the mounting bracket 21 in the front-rear direction T of the vehicle, the position of the door 30 may be adjusted in the front-rear direction T of the vehicle.

Finally, the front and rearward adjustment completion operation S115 of tightening the forward and rearward adjustment bolts 23 so that the adjusted position of the mounting bracket 21 is maintained is performed. The forward and rearward adjustment bolts 23 may be re-tightened and fastened to the vehicle body so that the position of the mounting bracket 21 is maintained.

Meanwhile, a case in which the position of the door 30 is adjusted in the width direction L of the vehicle will be described as follows.

The method of adjusting the step of the sliding-out type door assembly for a vehicle according to the embodiment includes a housing temporary assembly operation S121, a horizontal adjustment operation S123, and a horizontal adjustment completion operation S125 (see FIG. 12).

In the housing temporary assembly operation S121, the horizontal adjustment bolts 24 fastening the housing 11 in which the door 30 of the vehicle is installed are loosened from the step adjustment bracket 22 mounted on the mounting bracket 21 installed on the vehicle body so that the housing 11 is in the state of being temporarily assembled. To adjust the position of the door 30 in the width direction L of the vehicle, the horizontal adjustment bolts 24 may be partially loosened so that the housing 11 is in the state of being slidable with respect to the step adjustment bracket 22 in the width direction L of the vehicle. When the horizontal adjustment bolts 24 are loosened, the housing 11 may be in the state of being slidable with respect to the step adjustment bracket 22 and temporarily assembled.

In the horizontal adjustment operation S123, the housing 11 may be moved in the width direction L of the vehicle to adjust the position of the door 30 in the front-rear direction of the vehicle. Since the step adjustment bracket 22 is firmly fastened to the mounting bracket 21 and the housing 11 is slidable with respect to the step adjustment bracket 22, the position of the door 30 may be adjusted in the width direction L of the vehicle by adjusting the position of the housing 11.

Since the step adjustment bracket 22 is firmly fastened to the mounting bracket 21, the position of the door 30 may be adjusted in the width direction L of the vehicle by moving the housing 11 in the width direction L of the vehicle.

Then, through the horizontal adjustment completion operation S125, the horizontal adjustment bolts 24 may be tightened so that the adjusted position of the housing 11 is maintained.

In addition, a case in which the position of the door 30 is adjusted in the height direction H of the vehicle will be described as follows.

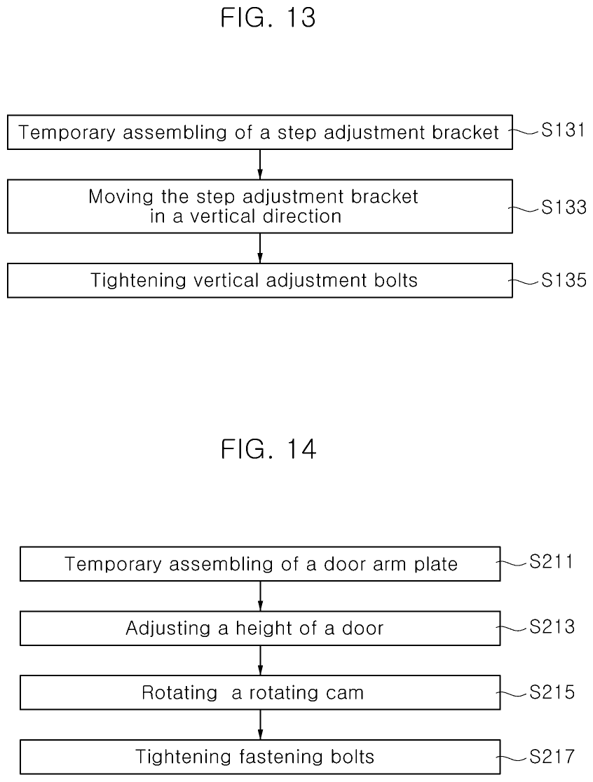

The method of adjusting the step of the sliding-out type door assembly for a vehicle according to the embodiment includes a step adjustment bracket temporary assembly operation S131, a vertical adjustment operation S133, and a vertical adjustment completion operation S135 (see FIG. 13).

In the step adjustment bracket temporary assembly operation S131, the vertical adjustment bolts 27 fastening the step adjustment bracket 22 to the mounting bracket 21 installed on the vehicle body are loosened so that the step adjustment bracket 22 is in the state of being temporarily assembled.

In the vertical adjustment operation S133, the position of the door 30 may be adjusted in the height direction of the vehicle by moving the step adjustment bracket 22 in the height direction H of the vehicle.

In particular, in the vertical adjustment operation S133, by adjusting the degree of the fine adjustment bolts 25 fastened to the step adjustment bracket 22, lower end portions of the fine adjustment bolts 25 push the mounting bracket 21 to finely adjust the height of the step adjustment bracket 22. When the fine adjustment bolts 25 are further tightened from the current state, the lower end portions of the fine adjustment bolts 25 relatively push the fastening part 21b of the mounting bracket 21, and thus the position of the door 30 moves upward while the step adjustment bracket 22 moves in a direction of moving up with respect to the mounting bracket 21.

Meanwhile, in the vertical adjustment operation S133, when the fine adjustment bolts 25 are further loosened from the current state, a gap may be formed between the lower end portions of the fine adjustment bolts 25 and the fastening part 21b, and at the same time, the step adjustment bracket 22 may move down due to weights of the door 30, the housing 11, etc. The housing 11 and the door 30 may move down by moving the step adjustment bracket 22 down so that the lower end portions of the fine adjustment bolts 25 are in contact with the fastening part 21b.

When the step adjustment bracket 22 is in the state of being temporarily assembled by loosening the vertical adjustment bolts 27, the position of the door 30 may also be adjusted by moving the step adjustment bracket 22 in the height direction H of the vehicle with respect to the mounting bracket 21 to adjust the position of the step adjustment bracket 22, but the door 30 may be precisely adjusted through the vertical adjustment operation S133. In particular, since the housing 11 in which the door, the motor unit 51, and the like are installed is heavy, it is difficult to vertically adjust the position of the door 30, but when the fine adjustment bolts 25 are rotated, the position of the door 30 may be easily adjusted by vertically moving the door, the housing 11, and the like even with a small force.

In the vertical adjustment completion operation S135, the vertical adjustment bolts 27 may be tightened so that the adjusted position of the step adjustment bracket 22 is maintained. When the adjustment of the position of the step adjustment bracket 22 with respect to the mounting bracket 21 is completed, the vertical adjustment bolts 27 may be completely fastened so that the step adjustment bracket 22 and the mounting bracket 21 are firmly fastened.

As described above, when the sliding-out type door is displaced from the correct position during assembly or use, the position of the door 30 may be adjusted so that the door 30 is easily positioned at the correct position. Therefore, the circumference of the door 30 may be in close contact with the vehicle body, thereby increasing airtightness when the door 30 is closed. By increasing the airtightness, it is possible to prevent a phenomenon in which foreign substances, noises, traveling wind, and the like are introduced into the vehicle from the outside.

What is claimed is:

1. A sliding-out type door assembly for a vehicle, the door assembly comprising:
a door coupled to a vehicle body of the vehicle;
a housing in which the door is slidably installed in a front-rear direction of the vehicle;
a mounting bracket disposed in the front-rear direction of the vehicle and slidably fastened in the front-rear direction of the vehicle by a predetermined length, the mounting bracket comprising a plurality of forward and rearward adjustment long holes in the front-rear direction of the vehicle;
a step adjustment bracket fastened to each of the mounting bracket and the housing; and
forward and rearward adjustment bolts passing through the forward and rearward adjustment long holes and fastened to the vehicle body.

2. The door assembly of claim 1, wherein:
an upper portion of the step adjustment bracket is bent to overlap an end portion of the housing;
a plurality of horizontal adjustment long holes is provided in a width direction of the vehicle; and
horizontal adjustment bolts pass through the horizontal adjustment long holes and are fastened to the housing.

3. The door assembly of claim 2, further comprising:
a transfer frame disposed in the width direction of the vehicle and coupled to the end portion of the housing, the transfer frame comprising a roller configured to move in the width direction of the vehicle installed thereon; and
fastening plates inserted into the transfer frame in the width direction of the vehicle and fastened to lower end portions of the horizontal adjustment bolts.

4. The door assembly of claim 1, further comprising:
a fastening part extending to be bent inward from an end portion of the mounting bracket in a width direction of the vehicle;
vertical adjustment long holes provided in a height direction of the vehicle in a lower end portion of the step adjustment bracket; and
vertical adjustment bolts passing through the vertical adjustment long holes and fastened to mounting holes provided in the fastening part.

5. The door assembly of claim 4, further comprising:
extensions protruding to an opposite side of the housing on a portion of the step adjustment bracket that is bent to overlap an end portion of the housing;
fine adjustment nuts provided on the extensions; and
fine adjustment bolts screw-coupled to the fine adjustment nuts and having lower end portions in contact with the fastening part.

6. A method of adjusting a position of the sliding-out type door assembly for the vehicle according to claim 1, the method comprising:
loosening the forward and rearward adjustment bolts that fasten the mounting bracket to the vehicle body such that the mounting bracket is in a state of being temporarily assembled;
adjusting a position of the door in the front-rear direction of the vehicle by moving the mounting bracket in the front-rear direction of the vehicle; and
tightening the forward and rearward adjustment bolts such that the adjusted position of the door is maintained.

7. A method of adjusting a position of a sliding-out type door assembly for a vehicle, the method comprising:
loosening horizontal adjustment bolts that fasten a housing in which a door of the vehicle is installed to a step adjustment bracket mounted on a mounting bracket installed on a vehicle body of the vehicle such that the housing is in a state of being temporarily assembled;
adjusting a position of the door in a front-rear direction of the vehicle by moving the housing in a width direction of the vehicle; and
tightening the horizontal adjustment bolts such that the adjusted position of the door is maintained.

8. A method of adjusting a position of a sliding-out type door assembly for a vehicle, the method comprising:
loosening vertical adjustment bolts that fasten a step adjustment bracket to a mounting bracket installed on a vehicle body of the vehicle such that the step adjustment bracket is in a state of being temporarily assembled;
adjusting a position of a door in a height direction of the vehicle by moving the step adjustment bracket in the height direction of the vehicle; and
tightening the vertical adjustment bolts such that the adjusted position of the door is maintained.

9. The method of claim 8, wherein adjusting the position of the door comprises adjusting degrees of fine adjustment bolts fastened to the step adjustment bracket and adjusting a height of the step adjustment bracket by lower end portions of the fine adjustment bolts pushing the mounting bracket.

10. A sliding-out type door assembly for a vehicle, the door assembly comprising:
a door coupled to a vehicle body of the vehicle, wherein the door comprises a door frame, and wherein vertical long holes are provided in the door frame in a height direction of the vehicle;
door arms configured to move the door while moving along a sliding guide disposed in a front-rear direction of the vehicle, the door arms comprising door arm plates provided on lower portions thereof;
mounting plates mounted inside the door frame of the door; and
fastening bolts passing through the door arm plates and the door frame and fastened to the mounting plates.

11. The door assembly of claim 10, further comprising:
horizontal long holes provided in the door frame in the front-rear direction of the vehicle; and
rotating cams rotatably installed on the mounting plates and positioned inside the horizontal long holes, wherein the rotating cams have a shape center and a rotation center eccentrically disposed.

12. The door assembly of claim 11, wherein an operation surface is provided on a circumference of the rotating cams in a planar shape.

13. The door assembly of claim 11, further comprising a pair of mounting plates disposed on the door frame at an interval, wherein the rotating cams are disposed on each of the mounting plates.

14. The door assembly of claim 11, further comprising:
through-holes provided in the door arm plates, wherein the rotating cams are exposed to the through-holes; and
caps coupled to the through-holes.

15. A method of adjusting a position of the sliding-out type door assembly for the vehicle according to claim 11, the method comprising:
loosening the fastening bolts that assemble the door arm plates provided on the lower portions of the door arms and the mounting plates mounted inside the door frame of the door such that the door arm plates are in a state of being temporarily assembled;
adjusting a position of the door by moving the door in the height direction of the vehicle; and
re-fastening the door arm plates to the mounting plates by tightening the fastening bolts.

16. The method of claim 15, further comprising rotating the rotating cams rotatably installed on the mounting plates such that heights of a first end portion and a second end portion of the door are differently adjusted between the steps of adjusting the position of the door and re-fastening the door arm plates to the mounting plates by tightening the fastening bolts.
